(19) United States
(12) Patent Application Publication
(10) Pub. No.: US 2005/0128390 A1
(43) Pub. Date: Jun. 16, 2005

(54) Transflective fringe field switching liquid crystal display

(75) Inventor: Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 10/997,704

(22) Filed: Nov. 24, 2004

(30) Foreign Application Priority Data
Dec. 12, 2003 (CN) 200310112580.5

(51) Int. Cl. G02F 1/1347; G02F 1/1343

(52) U.S. Cl. 349/114; 349/141

(57) ABSTRACT

A liquid crystal display (3) includes: a first substrate (30); a second substrate (32); a liquid crystal layer (31) interposed between the substrates; and a plurality of pixel regions each defined by respective pixel electrodes (324) and a common electrode (350), for application of a voltage to the liquid crystal layer and formation of a fringe electric field at each pixel region. Each pixel region includes a transmissive region and a reflective region. The liquid crystal display can effectively use light beams from the outside environment and from a backlight module. Therefore the liquid crystal display can be used not only in bright conditions, but also in dark conditions.

### BACKGROUND OF THE INVENTION

1. Field of the Invention

The present invention relates to liquid crystal displays, and especially to a transflective fringe field switching liquid crystal display (FFS LCD).

2. Description of the Prior Art

Recently, liquid crystal displays have become widely used in computer and communication products such as notebooks, cell phones and personal digital assistants. This is largely due to the thinness, lightness, and low power consumption of liquid crystal displays. Usually a liquid crystal display needs a planar light source, such as a backlight module, to display images. The backlight module is the main power consuming component of the liquid crystal display. In order to reduce power consumption, reflective type liquid crystal displays have been developed. A reflective liquid crystal display uses natural light beams to provide a planar light source. However, conventional reflective liquid crystal displays have some limitations; for example, a long response time and a narrow view angle.

To resolve the above-mentioned problems, a reflective fringe field switching liquid crystal display (FFS LCD) is described in U.S. Pat. No. 6,583,842 issued on Jun. 24, 2003. As represented in FIG. 4, the FFS LCD 1 includes a first substrate 10, a second substrate 12, and a liquid crystal layer 11 interposed between the substrates 10, 12.

The first substrate 10 comprises a first glass sheet 101 and a first alignment film 102. The first alignment film 102 is adhered on one surface (not labeled) of the first glass sheet 101, the surface facing the liquid crystal layer 11.

The second substrate 12 comprises a second glass sheet 121, a common electrode 122, an insulating layer 123, a plurality of pixel electrodes 124, and a second alignment film 125. The second glass sheet 121, the common electrode 122, and the insulating layer 123 are stacked from bottom to top in the order. The pixel electrodes 124 are formed on the insulating layer 123, and are spaced apart from and parallel to each other. The common electrode 122 is uniformly formed on the second glass sheet 121, and is made of a high reflectivity metal such as aluminum. Therefore, the common electrode 122 functions as both an electrically conductive electrode and a reflector.

The reflective FFS LCD 1 can efficiently use natural light beams, due to the reflection of the common electrode 122. Thus power consumption is reduced. Also, the common electrode 122 and the pixel electrodes 124 are both formed on the second substrate 12, which provides a dense fringe electric field parallel to the second substrate 12. The fringe electric field yields a fast response time and a wide view angle.

However, when the ambient environment is dark, the reflection of ambient light by the common electrode 122 is limited. The visibility of the reflective FFS LCD display 1 is poor. Conversely, a transmission type liquid crystal display is disadvantageous when the ambient environment is bright.

An improved liquid crystal display which overcomes the above-mentioned problems and shortcomings is desired.

### SUMMARY OF THE INVENTION

An object of the present invention is to provide a liquid crystal display which can be used not only in a bright environment but also in a dark environment, and which has a wide viewing angle.

To achieve the above object, a liquid crystal display of the present invention comprises: a first substrate; a second substrate; a liquid crystal layer between the first substrate and the second substrate; and a plurality of pixel regions each defined by respective pixel electrodes and a common electrode, for application of a voltage to the liquid crystal layer and formation of a fringe electric field at each pixel region. Each pixel region includes a transmissive region and a reflective region. The liquid crystal display can effectively use light beams from the outside environment and from a backlight module. Therefore the liquid crystal display can be used not only in bright conditions, but also in dark conditions.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a schematic, cross-sectional view of one sub-pixel area of a transflective FFS LCD according to a first embodiment of the present invention;

FIG. 2 is a schematic, cross-sectional view of one sub-pixel area of a transflective FFS LCD according to a second embodiment of the present invention;

FIG. 3 is a schematic, cross-sectional view of one sub-pixel area of a transflective FFS LCD according to a third embodiment of the present invention; and

FIG. 4 is a schematic, isometric view of one sub-pixel area of a conventional FFS LCD.

### DETAILED DESCRIPTION OF THE PRESENT INVENTION

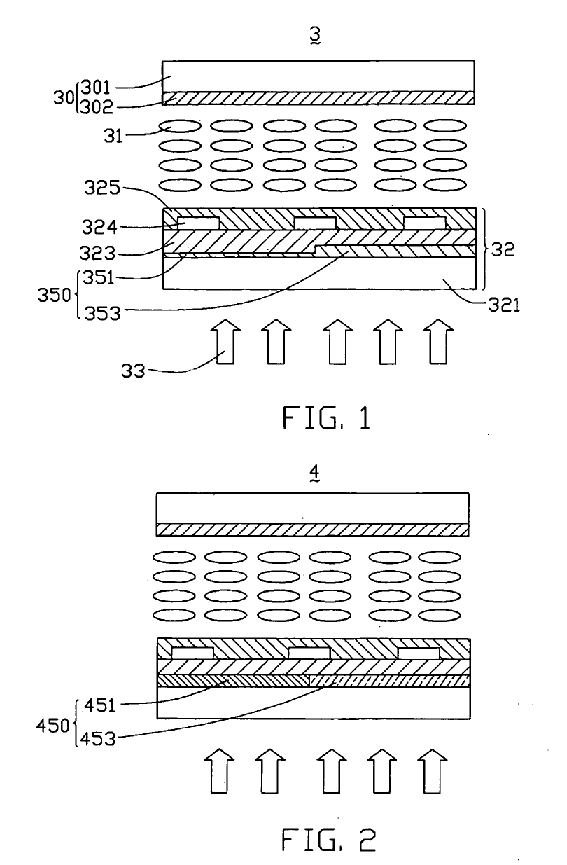

FIG. 1 is a view of one sub-pixel area of a transflective FFS LCD 3 according to the first embodiment of the present invention. The transflective FFS LCD 3 includes a first substrate 30, a second substrate 32, a liquid crystal layer 31, and a backlight module (not shown). The liquid crystal layer 31 is interposed between the first substrate 30 and the second substrate 32, and the backlight module is located below the second substrate 32.

The first substrate 30 comprises a first glass sheet 301, and a first alignment film 302 covering the first glass sheet 301 and facing the liquid crystal layer 31. The second substrate 32 comprises a second glass sheet 321, a common electrode 350, an insulating layer 323, a plurality of pixel electrodes 324, and a second alignment film 325. The second glass sheet 321, the common electrode 350, the insulating layer 323, and the pixel electrodes 324 are stacked from bottom to top in the order. A plurality of pixel regions is defined by the pixel electrodes 324 and the common electrode 350. Each of the pixel regions includes a transmissive region T and a reflective region R. Light reflected in the reflective region R and light transmitted through the transmissive region T is utilized in displaying an image.

The pixel electrodes 324 are transparent strip electrodes, and are spaced apart from and parallel to each other. The common electrode 350 has a transmissive area 351 according to the corresponding transmissive region T, and a reflective area 353 according to the corresponding reflective region R. The common electrode 350 is made of an aluminum film, and a transmission ratio of the aluminum film depends on a thickness thereof. When the thickness is equal to 100 nanometers, the transmission ratio is 1%. If the thickness is decreased, the transmission ratio increases proportionately, and vice versa. Therefore, the thickness of the reflective area 353 is defined as being more than 100 nanometers, and the thickness of the transmissive area 351 is defined as being less than 100 nanometers. Accordingly, the reflective area 353 can reflect natural light beams from the outside environment, and light beams 33 from the backlight module can pass through the transmissive area 351. In other words, the transflective FFS LCD 3 can be used in a dark environment and also in a bright environment.

The transmissive area 351 of the aluminum film has a higher impedance than the reflective area 353, because the thickness of the transmissive area 351 is less than that of the reflective area 353. In order to decrease the impedance of the transmissive area 351, an indium tin oxide (ITO) film (not shown) is attached to one surface thereof.

FIG. 2 is a view of one sub-pixel area of a transflective FFS LCD 4 according to the second embodiment of the present invention. Unlike the transflective FFS LCD 3, the transflective FFS LCD 4 has a common electrode 450, and the common electrode 450 includes a reflective area 453 and a transmissive area 451. The reflective area 453 is made of a metal film; for example, an aluminum film. A thickness of the aluminum film is more than 100 nanometers. The transmissive area 451 is made of an indium tin oxide (ITO) film or an indium zinc oxide (IZO) film. Both the indium tin oxide film and the indium zinc oxide film are transparent.

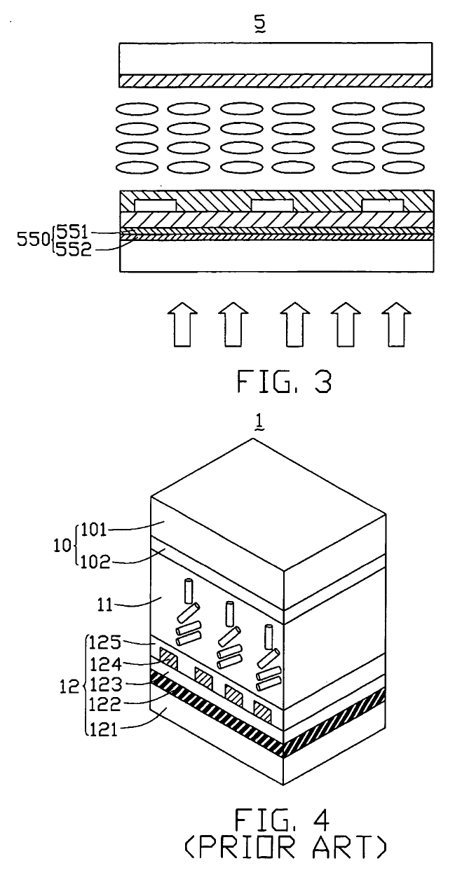

FIG. 3 is a view of one sub-pixel area of a transflective FFS LCD 5 according to the third embodiment of the present invention. A common electrode 550 includes a transparent conductive film 552, and a transflective film 551 covering the transparent conductive film 552. The transflective film 551 has a multi-layer construction, and commonly comprises seven to nine layers. In particular, the transflective film 551 comprises a plurality of layers of different transparent materials stacked one on the other in alternate fashion. The layers are typically indium tin oxide (ITO) films and indium zinc oxide (IZO) films. The refractive ratio and thickness of each of the layers can be configured according to need, and the number of layers can also be configured according to need. In this way, the transflective film 551 having a desired transmission ratio and a desired reflective ratio can be obtained.

The transflective FFS LCDs 3, 4, 5 can effectively use light beams from the outside environment and from respective backlight modules. Therefore the transflective FFS LCDs 3, 4, 5 can be used not only in bright conditions, but also in dark conditions. In addition, in a further embodiment, the common electrode and the pixel electrodes can be used to form a transflective element. That is, the common electrode is a transparent film, and the pixel electrodes are reflective elements. In particular, the common electrode can be an indium tin oxide film or an indium zinc oxide film. The pixel electrodes can be made of a metal, such as aluminum.

While the present invention has been described with reference to particular embodiments, the description is illustrative of the invention and is not to be construed as limiting the invention. Therefore, various modifications of the described embodiments can be made by those skilled in the art without departing from the true spirit and scope of the invention as defined by the appended claims.

1. A transflective fringe field switching liquid crystal display, comprising:
a first substrate;
a second substrate;
a liquid crystal layer between the first substrate and the second substrate; and
a plurality of pixel regions each defined by respective pixel electrodes and a common electrode, for application of a voltage to the liquid crystal layer and formation of a fringe electric field at each pixel region;
wherein each pixel region includes a transmissive region and a reflective region.

2. The transflective fringe field switching liquid crystal display of claim 1, wherein the common electrode is a transflective element which transmits and reflects light beams.

3. The transflective fringe field switching liquid crystal display of claim 2, wherein the common electrode includes a transmissive area and a reflective area.

4. The transflective fringe field switching liquid crystal display of claim 3, wherein the common electrode is made of a metal film.

5. The transflective fringe field switching liquid crystal display of claim 4, wherein the common electrode is made of an aluminum film.

6. The transflective fringe field switching liquid crystal display of claim 4, wherein a thickness of the reflective area is greater than a thickness of the transmissive area.

7. The transflective fringe field switching liquid crystal display of claim 6, wherein the thickness of the reflective area is more than 100 nanometers, and the thickness of the transmissive area is less than 100 nanometers.

8. The transflective fringe field switching liquid crystal display of claim 3, wherein the transmissive area is made of a transparent conductive material, and the reflective area is made of metal.

9. The transflective fringe field switching liquid crystal display of claim 8, wherein the transmissive area is made of an indium zinc oxide film.

10. The transflective fringe field switching liquid crystal display of claim 8, wherein the transmissive area is made of an indium tin oxide film.

11. The transflective fringe field switching liquid crystal display of claim 8, the reflective area is made of an aluminum film, and a thickness of the aluminum film is more than 100 nanometers.

12. The transflective fringe field switching liquid crystal display of claim 2, wherein the common electrode is a transparent conductive film, and the pixel electrodes are reflective elements.

13. The transflective fringe field switching liquid crystal display of claim 12, wherein the common electrode is an indium tin oxide film.

14. The transflective fringe field switching liquid crystal display of claim 12, wherein the common electrode is an indium zinc oxide film.

15. The transflective fringe field switching liquid crystal display of claim 12, wherein the pixel electrodes are made of metal.

16. A transflective fringe field switching liquid crystal display, comprising:
a first substrate;
a second substrate;
a liquid crystal layer between the first substrate and the second substrate; and
a plurality of pixel regions each defined by respective pixel electrodes and a common electrode, for application of a voltage to the liquid crystal layer and formation of a fringe electric field at each pixel region;
wherein the common electrode comprises a transparent conductive film, and a transflective film covering the transparent conductive film.

17. The transflective fringe field switching liquid crystal display of claim 16, wherein the transparent conductive film is an indium tin oxide film.

18. The transflective fringe field switching liquid crystal display of claim 16, wherein the transparent conductive film is an indium zinc oxide film.

19. The transflective fringe field switching liquid crystal display of claim 16, wherein the transflective film comprises a plurality of layers of different transparent conductive material arranged alternately one on the other.

20. A transflective fringe field switching liquid crystal display, comprising:
a first substrate;
a second substrate;
a liquid crystal layer between the first substrate and the second substrate; and
a plurality of pixel regions each defined by respective pixel electrodes and a common electrode, for application of a voltage to the liquid crystal layer and formation of a fringe electric field at each pixel region;
wherein the common electrode comprises a transparent conductive film, and a transflective film at least partially overlapped with the transparent conductive film.
